(19) United States
(12) Patent Application Publication
(10) Pub. No.: US 2009/0243130 A1
(43) Pub. Date: Oct. 1, 2009

(54) Method for Achieving a Fragrance Release with Sealing Parts

(76) Inventor: Jan Tuma, Herrenberg-Monchberg (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/226,322

(22) PCT Filed: May 16, 2007
(86) PCT No.: PCT/EP2007/004354

§ 371 Date: Oct. 15, 2008

(30) Foreign Application Priority Data
Jun. 16, 2006 (DE) 10 2006 027 849.6

(51) Int. Cl. B29C 47/06; B29C 47/92

(52) U.S. Cl. 264/40.4; 264/171.1; 264/173.16

(57) ABSTRACT

The invention relates to a method for achieving a fragrance release with release with parts which form a seal that, with correspondingly designed sealing parts, can be repeatedly opened and closed, wherein the respective sealing fan is produced from a meltable plastic material by means of an extrusion apparatus (18). Since the plastic material is intrinsically provided with at least one scent to which the respective scent is supplied by the extruder apparatus (18), the respective scent can be dispersed subtly and stored in high concentration in the plastic material of the spur scaling parts, in such a way that an extremely effective fragrant release of scent is possible according to the solution of the problem, as proposed by the invention.

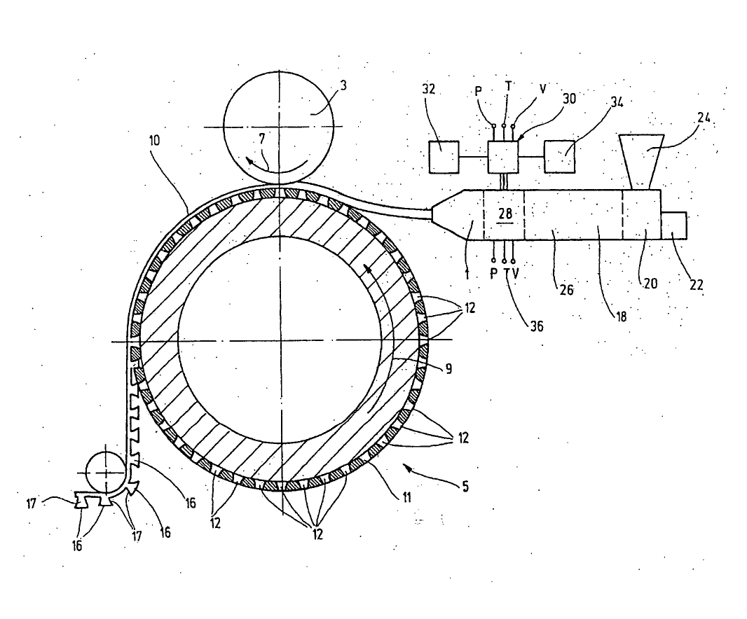

The invention relates to a method for achieving a fragrance release with sealing parts which form a seal that can be repeatedly opened and closed with the correspondingly designed sealing parts, the respective sealing part being produced from a meltable plastic material by means of an extrusion apparatus.

DE 697 24 657 T2 discloses placing a binding agent in which fragrance capsules are held between the corresponding sealing parts of an infant diaper or incontinence diaper. When these sealing parts are separated from one another, the fragrance capsules are at least partially torn open and release a pleasantly smelling fragrance into the vicinity. With this solution it is possible for the user to identify bad body odor which indicates the need to change the pertinent diaper; when the used diaper is folded together using the respective sealing parts, then, however, the user need not be permanently exposed to the bad odor, but said odor is now rather masked by the release of the fragrance by means of the torn fragrance capsule. Permanent scenting is not possible with the prior art diaper fragrance system.

DE 202 10 546 U1 discloses providing clothing textiles with interchangeable pheromone fragrance vehicles in which these pheromones, preferably affixed to a textile release carrier by means of so-called Velcro® fasteners, are attached to the clothing textiles. When the pheromone scent is used up, that is, dispersed, by means of a new Velcro fastener strip with a separate pheromone scent carrier, it can be re-attached to the textile clothing. By using specifically selected pheromones, the objective is to have the wearer of the article of clothing become more sexually attractive relative to other individuals. The utility model also describes the release of conventional fragrances and aromas via the indicated carrier system. This known solution is expensive to implement and the seal of the respective carrier being used is quickly worn out.

Proceeding from this prior art, the object of the invention therefore is to make available a method for achieving fragrance release with sealing parts which ensures permanent fragrance release even over longer time intervals, and which is economical to implement and reliable in use. This object is achieved by a method with the features specified in claim 1 in its entirety.

In that, as specified in the characterizing part of claim 1, the plastic material is intrinsically provided with at least one fragrance, in that the respective fragrance is supplied to the extrusion apparatus for producing the sealing part, the respective fragrance finely dispersed in a high concentration can be accommodated in the plastic material of the hook and loop fastener part so that extremely effective odiferous fragrance release is possible with the solution according to the invention. Since the fragrance is uniformly distributed in the plastic material of the sealing part, there is moreover the possibility of fragrance release over a large surface region of the sealing part. The intrinsic embedding of the fragrance in the plastic material of the sealing part moreover enables long-lasting and therefore permanently acting fragrance release. Even if the pertinent Velcro® sealing part is used in the clothing industry, washing of the textiles does not adversely affect the release of the fragrance so that even after several washes the sealing part which has been produced using the method according to the invention enables release of the fragrance when the clothing is being worn.

Since an extrusion apparatus is necessary at any rate for producing the sealing part, the method according to the invention can be carried out in an economical manner, and for the respective fragrance, in contrast to the disclosed prior art, there is no need for complex microencapsulation, with fragrance release being possible only after tearing or breaking of said microencapsulation. A fragrance in terms of this invention is considered to be all odiferous media, such as perfumes, aromas, irritant scented media as warnings, etc., but also nonodiferous substances such as hormones or messenger substances (pheromones).

The method according to the invention can be carried out in a so-called “master batch”, i.e., the respective fragrance optionally together with a carrier particle medium is supplied to the extrusion apparatus on the input side along with granulated plastic material, then the fragrance material and plastic material intrinsically bonding to one another only in the melting zone of the extrusion apparatus. Especially careful introduction for the fragrance in addition to possible carrier particles also consists in adding the respective fragrance in the so-called blending zone of the extrusion apparatus.

In one especially preferred embodiment of the method according to the invention, it is provided that the sealing part be built up preferably laminarly in several layers using a coextrusion apparatus with several delivery nozzles, and then at least one layer of the laminar structure can have the respective fragrance or preferably consists entirely of the fragrance material. In the latter case then the fragrance is preferably bound to the material of the fragrance carrier particles.

Other advantageous embodiments of the method according to the invention are the subject matter of the other dependent claims.

The method according to the invention is detailed below using one embodiment as shown in the single FIGURE. This FIGURE in a basic representation, which is not to scale, shows a highly schematically simplified and partially cut side view of a device for executing the method according to the invention.

The FIGURE schematically shows parts of a device for executing the method according to the invention, with an extrusion head 1 as the supply device for the especially thermoplastic material which is in the plastic or liquid state, and which is supplied to the gap between a pressure tool 3 and a molding tool 5 as a strip whose width corresponds to that of the sealing part to be produced. The pressure tool 3 is a pressure roll and the molding tool, which is designated as a whole as 5, is a molding roll. Both rolls are driven in the directions of rotation indicated in the FIGURE with curved arrows 7 and 9 so that a conveyor gap is formed between them, through which the plastic strip is conveyed in the transport direction, while at the same time the material is shaped into the carrier strip 10 of the sealing part and the carrier strip 10 on the side adjoining the molding roll acquires the shape which is necessary for forming the interlocking means (sealing elements in the form of shaped parts) by the shaping elements of the molding roll.

For this purpose the molding roll 5 on the periphery has a screen 11 with individual mold cavities 12. Furthermore, the mold cavities 12, as is not detailed, are distributed at regular intervals over the molding roll with its screen 11 on the outer peripheral side, the distribution and number being freely selectable. The mold cavities 12, in particular, are provided with boundary walls which run convexly so that a type of hyperboloid structure is formed which corresponds to the shaped element to be produced. With the indicated mold cavities 12 it is therefore possible to produce interlocking elements or sealing elements in the form of a stem part 17 which is provided with a head part 16. This production structure for the interlocking means or other sealing elements is conventional and, for example, is described in detail in WO 02/13647 A2, so that it is no longer detailed here.

The plastic materials to be processed which are being used here for the respective sealing part can be of a diverse nature, for instance, in the form of polyamides or polyolefins, such as polypropylene or polyethylene (HDPL and LDPL). Furthermore, other thermoplastics can also be used, such as polyester, polyethylene terephthalate, polystyrenes, polycarbonates, polymethyl methacrylates, ethylene, vinyl acetate copolymers, including acrylate modified ethylenes, vinyl acetate polymers and ethylene acrylic azide copolymers and also polyethylene styrenes. Furthermore, the use of duroplastics and elastomers is conceivable, such as naturally or synthetically producible rubber including styrene block copolymers with portions of isoprene, butadiene, or ethylene (butylene) blocks. Furthermore, metallocene-catalyzed polyolefin, polyurethane or polydiorganosiloxanes can be used. To stiffen the support web 10 and for strengthening purposes, ductile thermoplastics can be used, such as nylon or polyvinyl chloride. The respectively produced shaped element article in the form of the sealing part can also be provided with coverings and coatings which can be applied by vapor deposition or doctoring. Furthermore, to produce structuring for purposes of self-cleaning surfaces, aftertreatments are possible, either with a laser, ultrasound, or the like. In particular, production materials can be used which can be biodegradable, in particular those which can easily be intrinsically provided with fragrances.

The aforementioned extrusion head 1 with an extruder nozzle is part of an extrusion apparatus which is designated as a whole as 18. This extrusion apparatus 18 has an extruder worm which is not shown and which extends from the entry zone 20 to the extrusion head 1 with the extruder nozzle. This extruder worm is continuously driven by way of a drive, for example, in the form of an electric motor 22. The entry zone 20 is connected to an entry site 24 for supplying plastic granulate which is not detailed, for example, in the form of a thermoplastic material. Within the extrusion apparatus 18 the entry zone 20 is connected to a heating and compression zone 26 which on its side facing away from the entry zone 20 discharges into the blending zone 28 which in turn is adjoined by the extrusion head 1 with the extruder nozzle. The blending zone 28 is designed in particular to again make the potentially compressed plastic material more uniformly homogenous before this material is discharged. This structure of the extrusion apparatus 18 is conventional, so that it is no longer detailed here. In this configuration a standard extrusion apparatus is devised, as a result of which it is possible to supply the fragrance together with the plastic material used in a so-called master batch operation via the entry site 24.

But as shown in the FIGURE, it is also possible to connect the blending zone 28 to a metering device designated as a whole as 30 for fragrance delivery, this device being shown simplified as a black box diagram. In addition to a control device 32, the metering device 30 has at least one storage tank 34 for fragrances. Furthermore, sensors for pressure p, temperature T, and possibly for the velocity v of the plastic material used also end in the blending zone 28, the pertinent outputs of the sensors 36 being analogously connected to the inputs of the metering device 30. In addition to the indicated sensors, other sensors can be used (not shown), for example, for viscosity, linearity of the flow behavior, etc. Preferably it is furthermore provided that pressure sensors be placed at various locations in order in this way to be able to determine the pressure differences for appropriate triggering of the metering device 30 to obtain uniform, intrinsic delivery of fragrance into the melted plastic material.

The sensors 36 at any rate detect the respective operating state of the plastic material in the blending zone 28, and depending on this, the control device 32 feeds the fragrance stored in the tank 34 into the blending zone 28 of the extrusion apparatus 18. If changes on the plastic material, such as its compression, occur due to its properties, then less fragrance is added by way of the metering device 30 than if the plastic material is not packed too tightly.

In this way it is ensured by way of the metering device 30 that the fragrances are always delivered uniformly into the plastic material; later, with the finished end product, this results in the fragrance being continuously and uniformly incorporated. Furthermore, the metering device 30 optionally allows different types of fragrances to be taken from several storage tanks 34 which are not shown, mixed, and then in mixed form introduced into the plastic material at the same time or in alternation. If the support web 10 or the sealing part is to be built up in several layers as a whole in the coextrusion process, each layer can be assigned its own extrusion apparatus (not shown) with its own metering device for adding a fragrance, so that each layer could fundamentally be assigned its own fragrance release. Since the path between the blending zone 28 and the extrusion head 1 is very short, for a possible fragrance change direct switching to the next fragrance would be possible directly, and in this way the rejection rate for unwanted fragrance release or scented material can be largely reduced.

Within the scope of this invention, perfume oils or fragrances can be individual perfume compounds, for example, synthetic products of the type esters, ethers, aldehydes, ketones, alcohols, and hydrocarbons. Perfume compounds of the ester type are, for example, benzyl acetate, phenoxyethyl isobutyrate, p-tert-butylcyclohexyl acetate, linalyl acetate, dimethyl benzyl carbinyl acetate, phenylethyl acetate, linalyl benzoate, benzyl formiate, ethylmethylphenyl glycinate, allylcyclohexyl propionate, styrallyl propionate, and benzyl salicylate. The ethers include, for example, benzylethyl ether, the aldehydes include, for example, linear alkanals with 8-18 C atoms, citral, citronellal, citronellyl oxyacetaldehyde, cyclamen aldehyde, hydroxycitronellal, lilial and bourgeonal, the ketones include, for example, ionones, α-isomethyl ionone, and methyl-cadryl ketone, the alcohols include anethole, citronellol, eugenol, geraniol, linalool, phenylethyl alcohol, and terpineol, and the hydrocarbons include mainly the terpenes, such as limonene and pinene.

But preferably mixtures of various perfumes are used which together produce a pleasant note of fragrance. These perfume oils can also contain natural perfume mixtures, as are available from plant sources, for example, pine oil, citrus oil, jasmine oil, patchouli oil, rose oil, or ylang-ylang oil. The following are likewise suitable: muscatel, sage oil, chamomile oil, clove oil, balm mint oil, mint oil, cinnamon leaf oil, linden blossom oil, juniper berry oil, vetiver oil, olibanum oil, galbanum oil and labdanum oil, as well as orange blossom oil, neroliol, orange peel oil, and sandalwood oil.

Furthermore, for use in sealing parts so-called tenacious perfumes are suited, for example, in the form of essential oils, such as angelica root oil, anise oil, arnica blossom oil, basil oil, bay oil, bergamot oil, champaca blossom oil, silver fir oil, silver fir cone oil, elemi oil, eucalyptus oil, fennel oil, pine needle oil, galbanum oil, geranium oil, ginger grass oil, guaiac wood oil, gurjun balsam oil, helichrysum oil, ho oil, ginger oil, iris oil, cajeput oil, sweet flag oil, chamomile oil, camphor oil, kanag oil, cardamom oil, cassia oil, pine needle oil, copaiba resin oil, coriander oil, curled mint oil, caraway oil, cumin oil, lavender oil, lemon grass oil, lime oil, mandarin oil, balm mint oil, musk seed oil, myrrh oil, clove oil, neroli oil, niaouli oil, olibanum oil, orange oil, oregano oil, palmarosa oil, patchouli oil, Peruvian balsam oil, petit grain oil, pepper oil, peppermint oil, pimento oil, pine oil, rose oil, rosemary oil, sandalwood oil, celery oil, oil of spike, Japanese anise oil, turpentine oil, thuja oil, thyme oil, verbena oil, vetiver oil, juniper berry oil, wormwood oil, wintergreen oil, ylang-ylang oil, hyssop oil, cinnamon oil, cinnamon leaf oil, citrus oil, and cypress oil.

Furthermore, so-called higher boiling or solid perfumes of natural or synthetic origin can be used as the fragrance. These compounds include the following compounds and mixtures thereof: ambrettolide, α-amyl cinnamic aldehyde, anethole, anise aldehyde, anise alcohol, anisole, methyl anthranilate, acetophenone, benzyl acetone, benzaldehyde, benzoic acid ethyl ester, benzophenone, benzyl alcohol, benzyl acetate, benzyl benzoate, benzyl formiate, benzyl valerianate, borneol, bornyl acetate, α-bromostyrene, n-decyl aldehyde, n-dodecyl aldehyde, eugenol, eugenol methyl ester, eucalyptol, farnesol, fenchone, fenchyl acetate, geranyl acetate, geranyl formiate, heliotropin, heptyne carboxylic acid methyl ester, heptaldehyde, hydroquinone dimethyl ether, hydroxycinnamaldehyde, hydroxycinnamyl alcohol, indole, irone, isoeugenol, isoeugenol methyl ester, isosafrol, jamson, camphor, carvacrol, carvone, p-cresol methyl ether, cumarine, p-methoxyacetophenone, methyl-n-amyl ketone, methylanthranilic acid methyl ester, p-methyl acetophenone, methyl chavicol, p-methyl quinoline, methyl-β-naphthyl ketone, methyl-n-nonyl acetaldehyde, methyl-n-nonyl ketone, muscone, β-naphtholethyl ether, β-naphthol methyl ether, nerol nitrobenzene, n-nonyl aldehyde, nonyl alcohol, n-octyl aldehyde, p-oxy-acetophenone, pentadecanolide, β-phenylethyl alcohol, phenylacetaldehyde dimethyacetal, phenylacetic acid, pulegone, safrole, salicylic acid isoamyl ester, salicylic acid methyl ester, salicylic acid hexyl ester, salicylic acid cyclohexyl ester, santalol, skatole, terpineol, thymene, thymol, γ-undelactone, vanillin, veratric aldehyde, cinnamaldehyde, cinnamyl alcohol, cinnamic acid, ethyl cinnamate, benzyl cinnamate. More highly volatile perfumes include in particular the lower boiling perfumes of natural or synthetic origin, which can be used alone or in mixtures. Examples of more highly volatile perfumes are alkyl isothiocyanates (alkyl isothiocyanates), butanedione, limonene, linalool, linayl acetate and propionate, menthol, menthone, methyl-n-heptenone, phellandrene, phenyl acetaldehyde, terpinyl acetate, citral, citronellal.

To produce a citrus scent, 3,7-dimethyl-2,6-octadiene-1-al has proven especially favorable. For the pertinent geranium aldehyde which can be chemically characterized as a double-unsaturated monoterpene aldehyde, a very pronounced citrus scent is formed. The pertinent fragrance is known as “citral” in the marketplace and is the main component of the essential oils of Cymbopogon citratus STAPF (lemon grass oil) and Litsea cubeba PERS. (May-Chang oil) which are produced by steam distillation. In addition to the production of citral from the two easily available essential oils, the aldehyde as described can also be synthetically produced by oxidation of the corresponding alcohol geraniol.

With the method according to the invention, the indicated fragrances can be directly processed; but preferably it is also possible to attach these fragrances to so-called fragrance carrier particles. The three-dimensional shape of these particles is optional and is limited solely by the technical possibilities in their production and processing. In addition to cubic and cuboidal structures, possible three-dimensional shapes are spheres, cylinders, but also regular polyhedral structures, for example, in the form of octahedra or dodecahedra. To obtain a large effective surface the roughening of the particle surface and/or a star-shaped ray arrangement is recommended. But fundamentally the carrier material in the form of fragrance carrier particles can be any substances which are able to adsorb and/or absorb the aforementioned fragrances. In particular, polymers, but also porous inorganic materials such as silica gels or zeolites have proven effective. Silica gels or zeolites are already very extensively used in filtration engineering to increase the surface action of filter substances. The corresponding products could also be used for fragrance transport. These carrier particles stabilize the incorporation of the fragrance in the extruder process.

The carrier particles used can also serve to impart further properties to the plastic material of the sealing part. Thus the fragrance carrier particles could be used, for example, to control microorganisms such as bacteria and could contain suitable antimicrobial agents. These substances could be, for example, conventional bactericides or fungicides. But use of the respective fragrance carrier particles modified accordingly for dye transport into the plastic material of the sealing parts is especially preferred. In particular, by adding liquid dyes by way of the fragrance carrier particle on the sealing part it can be colored corresponding to the fragrance used. For example, it is convenient for the consumer if particles with a citrus scent have a yellow color, while for particles with an apple or herbal scent, a green color is often preferred. For these liquid dyes color pigments, ground, in particular powdered, are placed in a stabilizing binder, such as fatty acid esters or fatty acid ester ethoxylates, paraffin oils, vegetable oils, softeners, multivalent alcohols or amines, and alcohol ethoxylates. It has been shown that these binders bond easily to the indicated fragrance carrier particles.

For the production process to be carried out it has proven effective to form these fragrance carrier particles in the region of 0.2 mm diameter and to fill the plastic material with fragrances to between 5 and 30%. The method according to the invention can be carried out extremely economically and results in very large amounts of scented sealing part material. The fragrance cannot be rubbed off and due to its intrinsic incorporation into the sealing part, long-lasting scenting of the vicinity can be expected. In particular, when using citrus scents increased use of these Velcro® fasteners in the sanitary domain is possible.

1. A method for achieving a fragrance release with sealing parts which form a seal that can be repeatedly opened and closed with the correspondingly designed sealing parts, the respective sealing part being produced from a meltable plastic material by means of an extrusion apparatus (18), characterized in that the plastic material is intrinsically provided with at least one fragrance, in that the respective fragrance is supplied to the extrusion apparatus (18).

2. The method according to claim 1, characterized in that the respective fragrance is coupled to fragrance carrier particles which are supplied to the extrusion apparatus (18).

3 The method according to claim 1, characterized in that the fragrance for the extrusion apparatus (18) is supplied as a “master batch” process and/or in the blending zone (28) of the extrusion apparatus (18).

4. The method according to claim 1, characterized in that depending on the degree of melting of the plastic material and/or its temperature (T), a variable amount of fragrance is supplied by means of a metering device (30) such that the degree of scenting for the sealing part is made uniform.

5. The method according to claim 1, characterized in that the sealing part built up in layers is obtained by a coextrusion apparatus and that at least one layer has the respective fragrance.

6. The method according to claim 1, characterized in that the fragrance carrier particles are less than 1 mm in diameter, preferably 0.2 mm, and are used in spherical form.

7. The method according to claim 1, characterized in that the respective fragrance is bonded to a dye, in particular in the form of a liquid dye.

8. The method according to claim 1, characterized in that fragrances and fragrance carrier particles are used at a rate between 5 and 30% of the dosage of plastic material.
